(19) United States
(12) Patent Application Publication
(10) Pub. No.: US 2011/0289535 A1
(43) Pub. Date: Nov. 24, 2011

(54) Personalized and Multiuser Interactive Content System and Method

(75) Inventors: Bob Saffari, Redwood City, CA (US); Gregory Maertens, Redwood City, CA (US)

(73) Assignee: MOZAIK MULTIMEDIA, Redwood City, CA (US)

(21) Appl. No.: 12/969,562

(22) Filed: Dec. 15, 2010

Related U.S. Application Data
(60) Provisional application No. 61/286,791, filed on Dec. 16, 2009.
(60) Provisional application No. 61/286,787, filed on Dec. 16, 2009.

(51) Int. Cl. H04N 5/445

(52) U.S. Cl. 725/61

(57) ABSTRACT

An interactive content system and method are provided that allows a user to interact with a piece of content. In another aspect, a multiuser interactive content system and method are provided that allows a plurality of users to independently interact with a piece of content.

### PRIORITY CLAIMS/RELATED APPLICATIONS

This application claims the benefit under 35 USC 119(e) to U.S. Provisional Patent Application Ser. No. 61/286,791, filed on Dec. 16, 2009 with the title “PERSONALIZED INTERACTIVE CONTENT SYSTEM AND METHOD” and U.S. Provisional Patent Application Ser. No. 61/286,787 filed on Dec. 16, 2009 with the title “PERSONALIZED AND MULTIUSER INTERACTIVE CONTENT SYSTEM AND METHOD”, both of which are incorporated by reference herein.

### FIELD

The disclosure relates generally to a system and method for interacting with content.

### BACKGROUND

Digital Versatile Discs (DVDs) and newer digital media (such as Blu Ray discs that have a higher storage capacity that a DVD) provide a person who purchases a piece of content, such as a movie, on the digital media with additional features that do not exist in the movie itself. For example, the movie is often broken up into chapters that allows a user to quickly navigate to different locations in the movie. The digital media also often has trailers for new movies and possibly other content that may be related to the movie. However, the digital media does not permit more interactivity between the viewer of the digital media and the content on the digital media and it is desirable to be able to provide that additional interactivity and it is to this end that the disclosure is directed.

In addition, although some media players provide chapter selection for content viewing, most of the streaming and video on demand (VOD) applications never do. In fact, all broadcast video distribution with DVR capabilities have no way of navigating the content (searching) based on context at frame level accuracy. They all jump over frames in (Forward and Backward) directions similar to VHS players. These methods of navigation are time consuming, hard to find the exact scene and not “contextual” meaning you can find a scene based on people, produce, places, phrases, etc. There is a need to identify scene of interest based on a more granular and accurate way.

### BRIEF DESCRIPTION OF THE DRAWINGS

FIG. 1 illustrates a multiuser interactive content system and method;

FIG. 2 illustrates an example of an implementation of the multiuser interactive content system and method;

FIG. 3 illustrates more details of the media player shown in FIG. 2;

FIG. 4 is a flowchart of a method for providing interactive content;

FIG. 5 illustrates more details of the interactive content system shown in FIG. 1;

FIG. 6 illustrates an example of a piece of content with encoded interactive content using the interactive content system;

FIG. 7 illustrates a scene from a piece of content being displayed to a user;

FIG. 8 illustrates the scene from the piece of content in FIG. 7 when the interactive content system is activated by the user;

FIG. 9 illustrates the scene from the piece of content in FIG. 7 when a menu user interface of the interactive content system is displayed;

FIGS. 10 and 11 illustrate an example of interactive content information being displayed for a piece of interactive content in the piece of content;

FIG. 12 illustrates an example of the user interface indicating that the user has added an item to a shopping card that is part of the interactive content system;

FIG. 13 illustrates an example of the user interface for the shopping cart of the interactive content system;

FIG. 14 illustrates an example of the user interface for signing into the ecommerce portion of the interactive content system;

FIGS. 15-19 illustrate the user interfaces for an ecommerce transaction using the interactive content system;

FIGS. 20-22 illustrates example of the scenes of the content that have a particular piece of interactive content;

FIG. 23 illustrates an example of the computing device user interface when the computing device is detecting a content system;

FIG. 24 illustrates an example of the computing device user interface when the computing device is being synched to a particular piece of content displayed on the content system;

FIG. 25 illustrates an example of the computing device user interface showing the details of the particular piece of content;

FIG. 26 illustrates an example of the computing device user interface once the computing device is synched to a particular piece of content and has captured a scene;

FIG. 27 illustrates an example of the computing device user interface when the user has selected a piece of interactive content in the synched scene of the piece of content;

FIG. 28 illustrates multiple user independently interacting with content using the multiuser interactive content system;

FIGS. 29A and 29B illustrate examples of voting that can be done using a computing device and the interactive content system;

FIG. 30 illustrates an example of participating in a game show using a computing device and the interactive content system;

FIG. 31 illustrates an example of a user being able to share a piece of captured content using the interactive content system; and

FIG. 32 illustrates an example of a messaging material added into a piece of captured content and an interactive advertisement using the interactive content system.

### DETAILED DESCRIPTION OF ONE OR MORE EMBODIMENTS

The disclosure is particularly applicable to a media player implementation of the interactive content system and method and it is in this context that the disclosure will be described. It will be appreciated, however, that the system and method has greater utility since the system and method can be implemented in other known manners or may be implemented on other computing devices that are capable of displaying content.

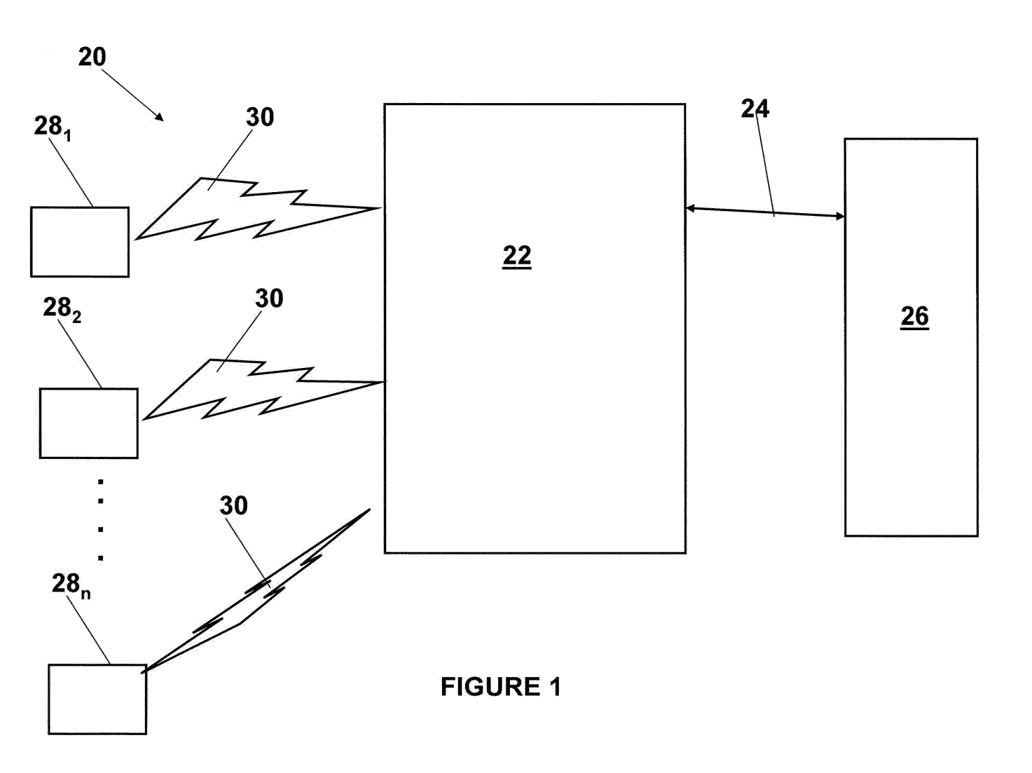

FIG. 1 illustrates an interactive content system and method 20 that allows a user to interact with content from a content system 22 that is a processing unit based device with sufficient processing power, memory, connectivity, input/output devices and a display to display content to the user and allow the user to interact with the content as described below. For example, the content system may be a digital disc player, a personal computer, a camera or camcorder that have a two way IP connectivity (wherein each one can capture images or videos or both), a laptop computer, all types of consumer two way IP enabled devices, any set-top boxes (cable, IPTV, satellite, over-the-top) and TVs that have two way IP connectivity. The content navigated by the system can be content on piece of media, but may also be content in the local cache, memory, hard disk drive and/or flash memory. The system provides for content navigation of what is being streamed to the box including scene navigation and “within the scene” navigation.

The content system 22 may be connected, over a link 24, to an interactive content system 26 so that the content system is able to retrieve interactive content and display it to a user. The link 24 may be a wired or wireless link. The interactive content may be information about one or more products, one or more people, one or more places/locations, one or more music/soundtracks, one or more services and/or one or more words/phrases that are associated with the content being displayed on the content system as described below in more detail.

The system may further comprise one or more computing devices 28 (such as computing device 28₁, 28₂ to 28ₙ as shown in FIG. 1) over a link 30 (wherein the link may be wired or wireless) to control the content system 22 and interact with the content being displayed to each user on the content system. However, the system can also be used by a single user with a single computing device. Each computing device may be a processing unit based device with sufficient processing power, memory, connectivity, input/output devices and a display to display content to the user and allow the user to interact with the content as described below. For example, each computing device 28 may be a smart phone (iPhone, Blackerry device, Palm device, Android device, etc.), a cellular phone, a PDA, a palm top computer, a laptop computer, a play console/video game device, smart remote TV controller, a camera or camcorder that have a two way IP connectivity (wherein each one can capture images or videos or both), tablet PCs, Digital Photo devices with IP connectivity; and other personal communication devices. Each computing device may have wired or wireless device connectivity using a device to device communication protocol to send the interactive content information.

When the interactive content is provided to each computing device 28, the media and other relevant information received on the smart phone, remote, etc could come from the box or via the backend server/web. The one or more computing devices allow a plurality of user to simultaneously interact with the content. Each user, using a particular computing device, is able to synchronize to a scene of the content (as described below in more detail) and select any of the interactive content landmarks (as described below in more detail).

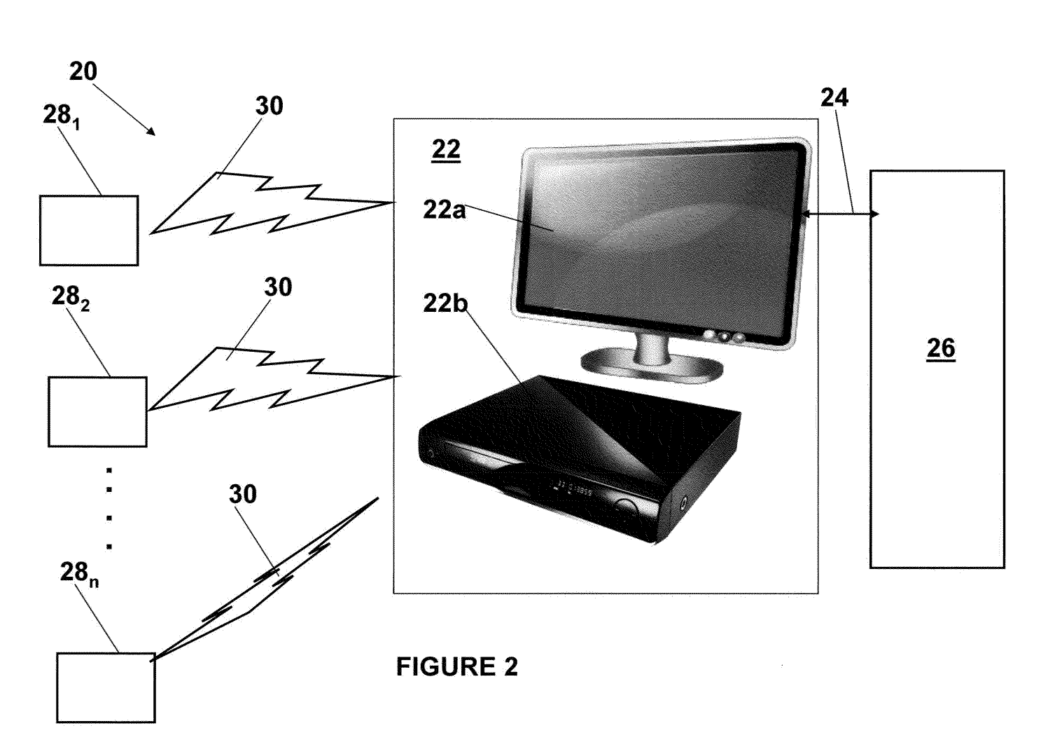

FIG. 2 illustrates an example of an implementation of the interactive content system and method 20 in which the content system 22 is a media player. In particular, the content system may further comprise a display 22a and a media player 22b, such as a digital disc player. In one embodiment, a piece of software (with a plurality of lines of computer code) may be stored on the digital disc being played by the media player 22b wherein the piece of software implements the user interface and interactivity of the content system. Thus, in this embodiment, the media player 22b does not need to be modified to implement the interactive content system. In another embodiment (that has the content system 22 generally or the media player 22b), the user interface and interactivity of the content system may be implemented based on a plurality of lines of computer code downloaded to the content system over the link 24. In yet another embodiment, the user interface and interactivity of the content system may be implemented using a piece of software (with a plurality of lines of computer code) that is stored in the media player/content system. In this implementation, the computing device 28 may also be a television/media player remote device.

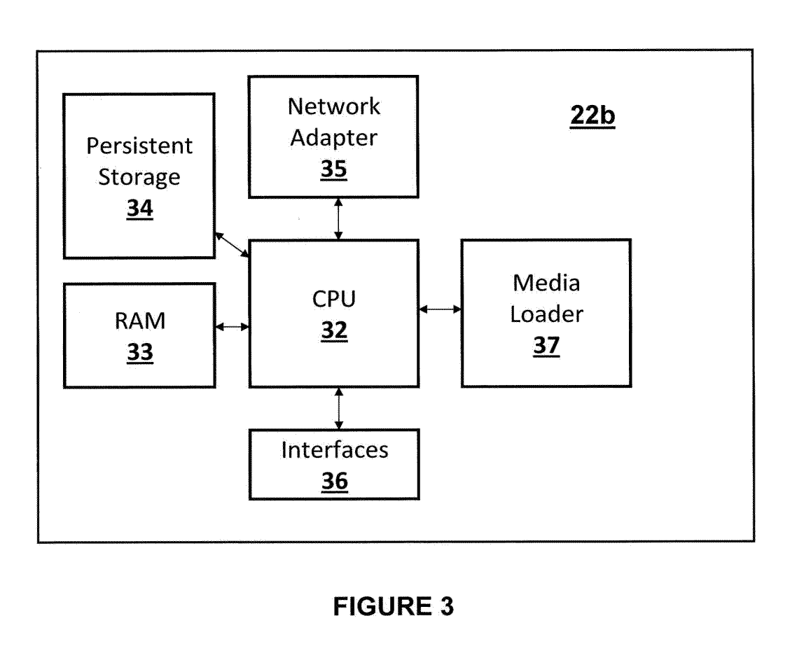

FIG. 3 illustrates more details of the media player 22b shown in FIG. 2 and in particular shows the typical elements of the media player. The media player 22b may further comprise a CPU 32, random access memory 33, a persistent storage device 34, a network adapter 35, a set of interfaces 36 and a media loader 37 which are interconnected together wherein the CPU controls the overall operation of the media player. The media player is capable of loading a piece of digital media using the media loader 37, reading the digital data from the digital media, processing the digital data so that it can be displayed on a display (not shown) that is connected to the media player. The RAM may be used for temporary storage of data/code while the persistent storage device is used for more permanent storage of the data/code. The network adapter 35 allows the media player to connect to a link such as the link to the interactive content system while the interfaces allows the media player to connect to input/output devices such as the remote as shown in FIG. 2.

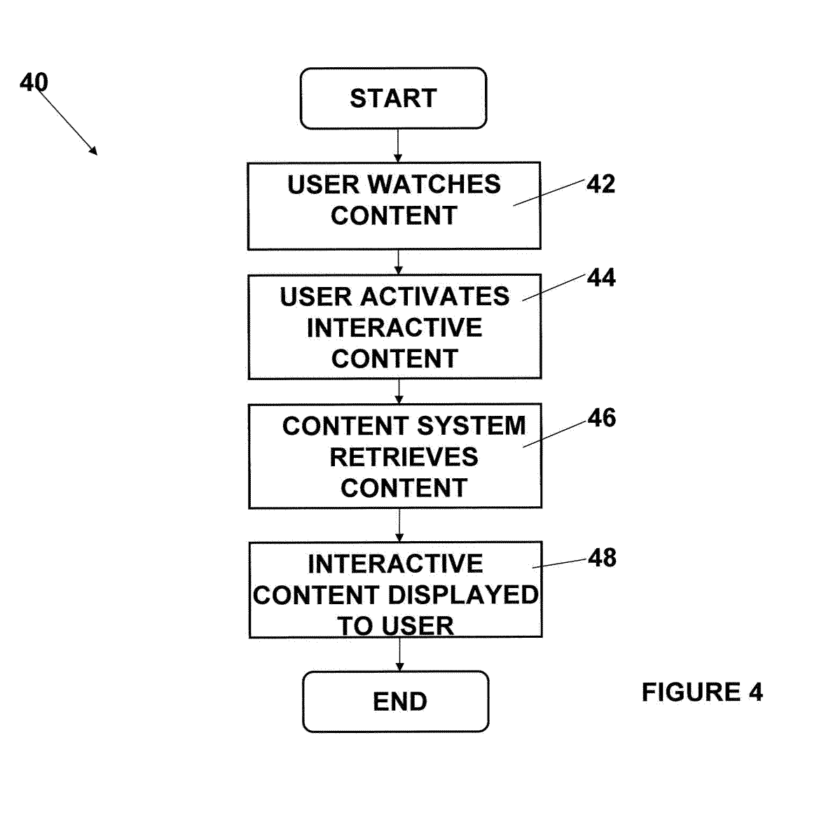

FIG. 4 is a flowchart of a method 40 for providing interactive content using the content system shown in FIG. 1 or 2. As with other content systems, the user can watch a piece of content (42). Unlike other content systems, the user can activate the interactive content system (44) in some manner (such as using the remote in the implementation shown in FIG. 2). Once the user activates the interactive content system, the content system (based on interactive content code that can be executed by the processing unit of the content system) retrieves the interactive content (46) and the interactive content is displayed to the user (48). Examples of the interactive content that can be displayed to the user with the interactive content system are shown in the following figures and described below in detail.

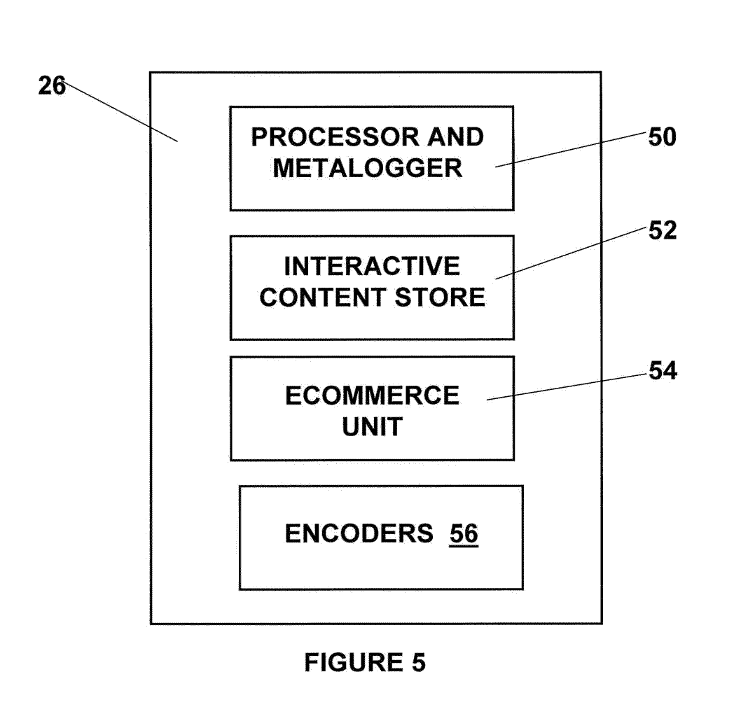

FIG. 5 illustrates more details of the interactive content system 26 shown in FIG. 1. The interactive content system 26 may be implemented as one or more server computers with typical server computer components that execute a plurality of lines of computer code to implement the functions and operations of the interactive content system. The interactive content system may have a processor and metalogger unit 50, an interactive content store 52, an ecommerce unit 54 and one or more encoders 56. The interactive content system may process a piece of content to extract keywords for interactive content information (and the location of each piece of interactive content in the piece of content) using the processor and metalogger unit 50 which is then stored in the store 52. The interactive content information and the location of the interactive content may then be stored in the store 52. In one embodiment, the code to implement the interactive system as well as the keywords/locations of the interactive content for a particular piece of content are loaded onto a piece of digital media with the piece of content. As described above, the interactive content may be one or more products, one or more people, one or more places/locations, one or more music/soundtracks, one or more services and/or one or more words/phrases that are associated with the content. The interactive content information extracted by the metalogger may include an identity of a particular piece of interactive content, a link to the manufacturer of the piece of interactive content, a link to an advertisement for the particular piece of interactive content and the like. The interactive content system 26 also has the ecommerce unit 54 that is used to process transactions as described below that are facilitated by the interactive content system to satisfy the buy impulse of a user when they are viewing the content. The interactive content system may also re-encode the content using the encoders 56. Now, the user interface of the interactive content system and examples of the interactive content are described in more detail.

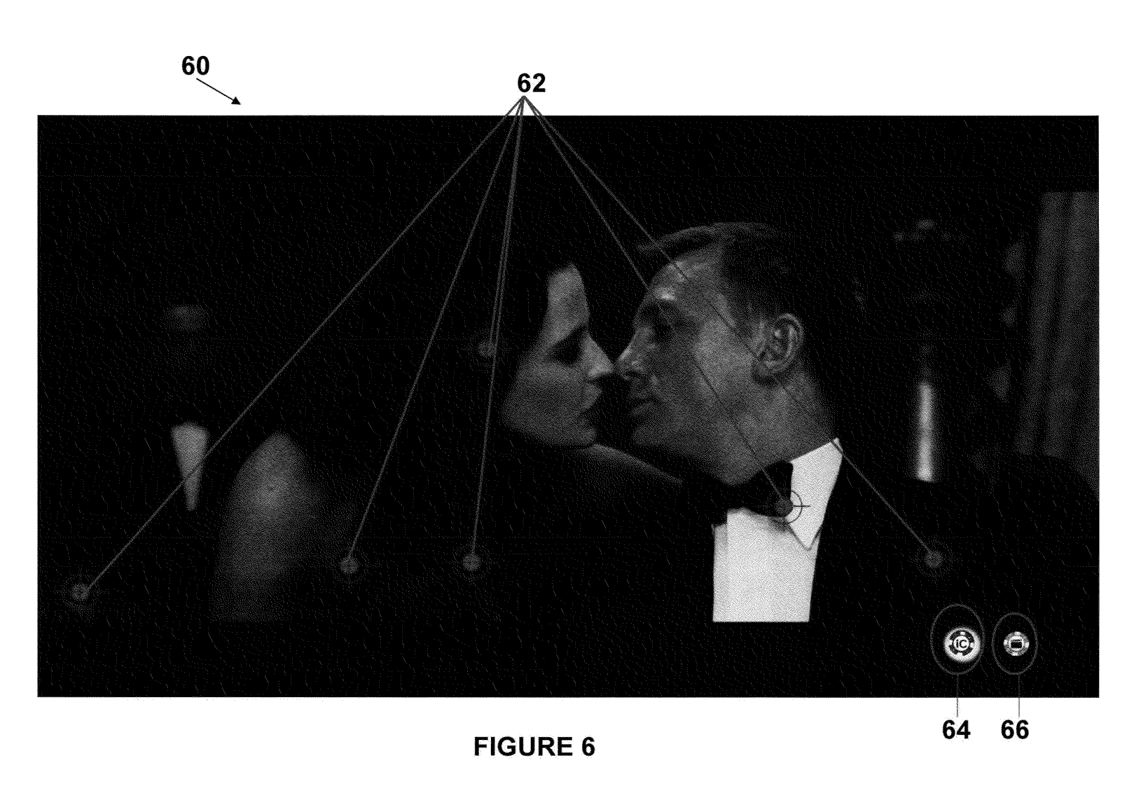

FIG. 6 illustrates an example of a piece of content 60 with encoded interactive content using the interactive content system once the piece of content has been processed by the interactive content system. As shown, in the scene shown, one or more interactive content landmarks 62 are shown wherein each landmark indicates that additional information is available about a piece of interactive content in the piece of content. For example, the landmark marking the bow tie indicates that the interactive content system has additional information about the bowtie. Similarly, the landmark marking the tuxedo indicates that the interactive content system has additional information about the tuxedo. Typically, the landmarks are not visible to the user as they distract from the viewing of the content. However, the interactive system provides a mode in which the landmarks can be displayed so that the user can see the interactive content in the piece of content or in a scene of the piece of content as shown in FIG. 6.

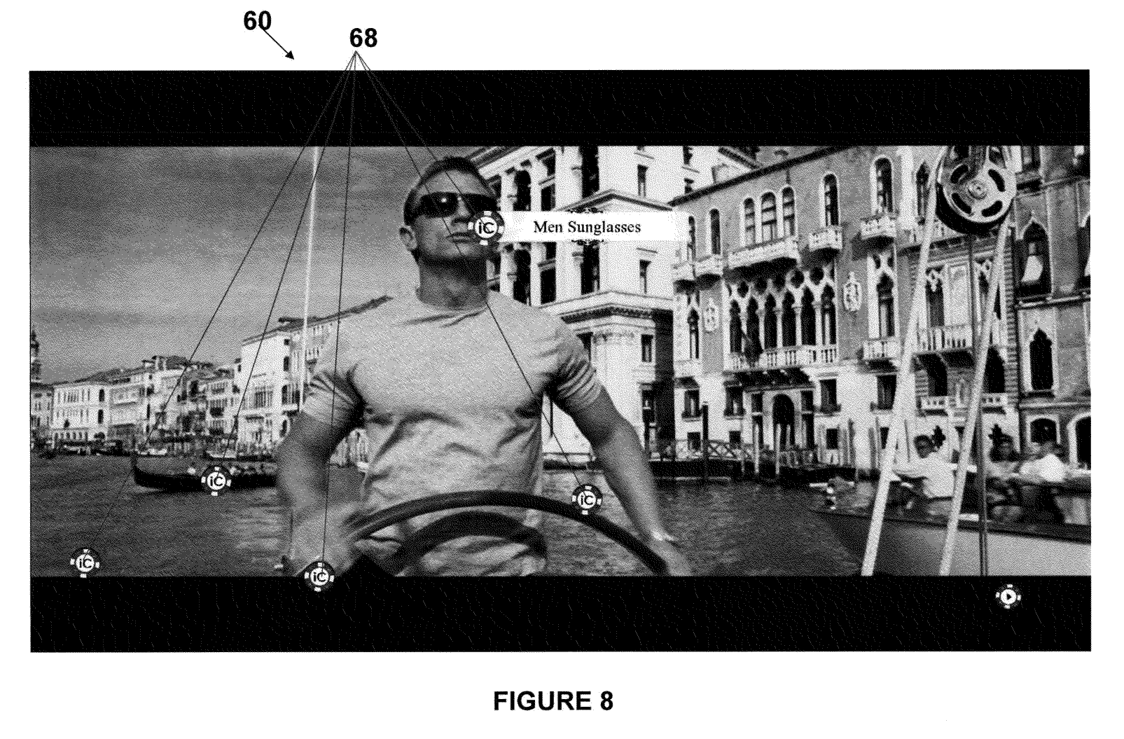

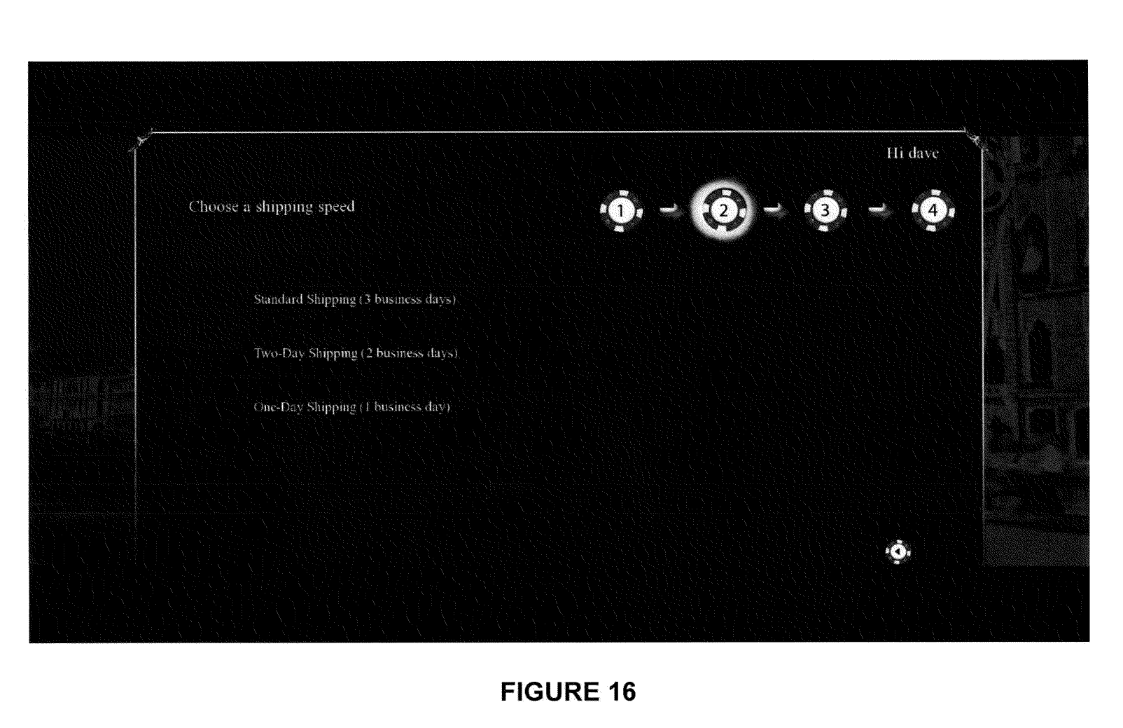

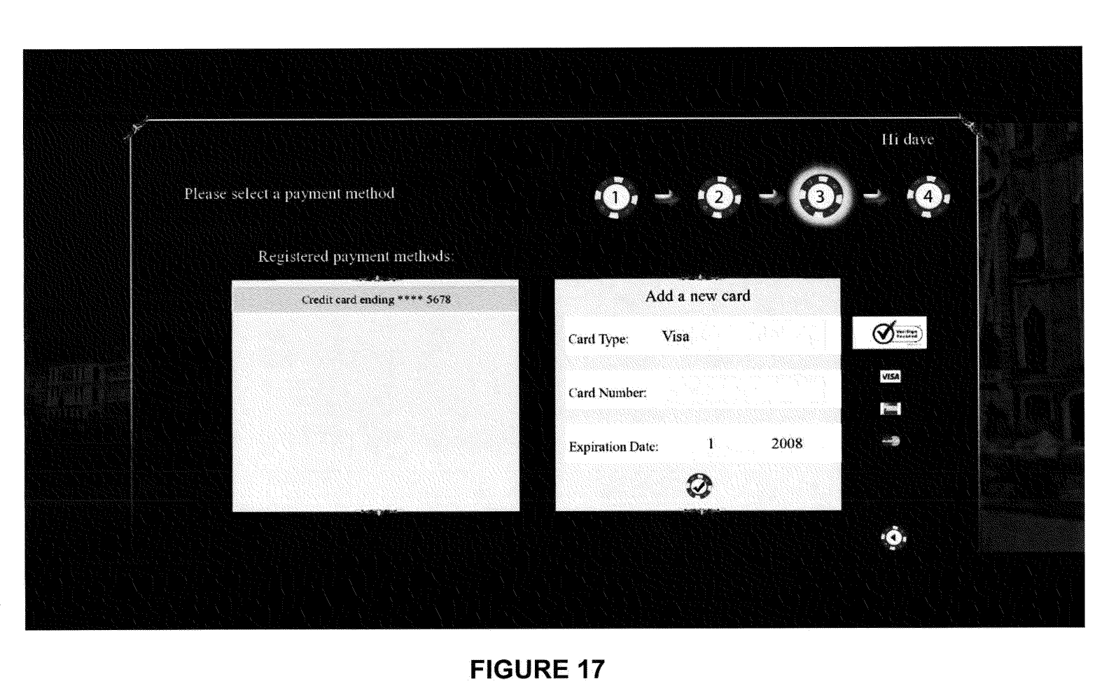

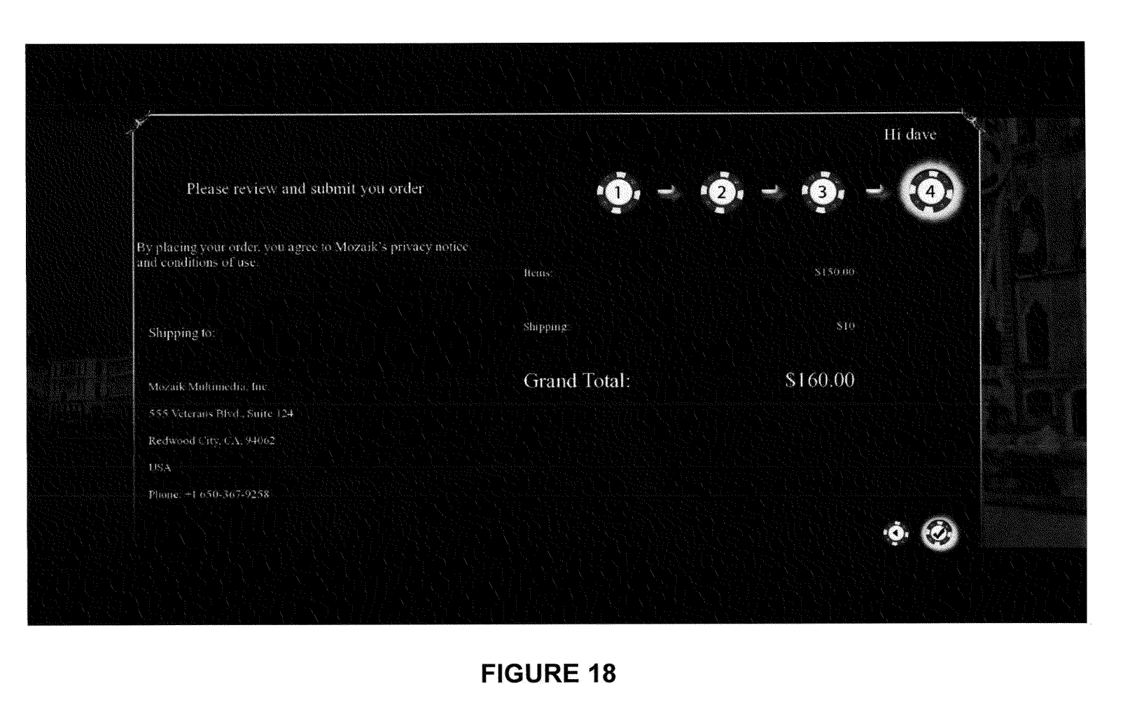

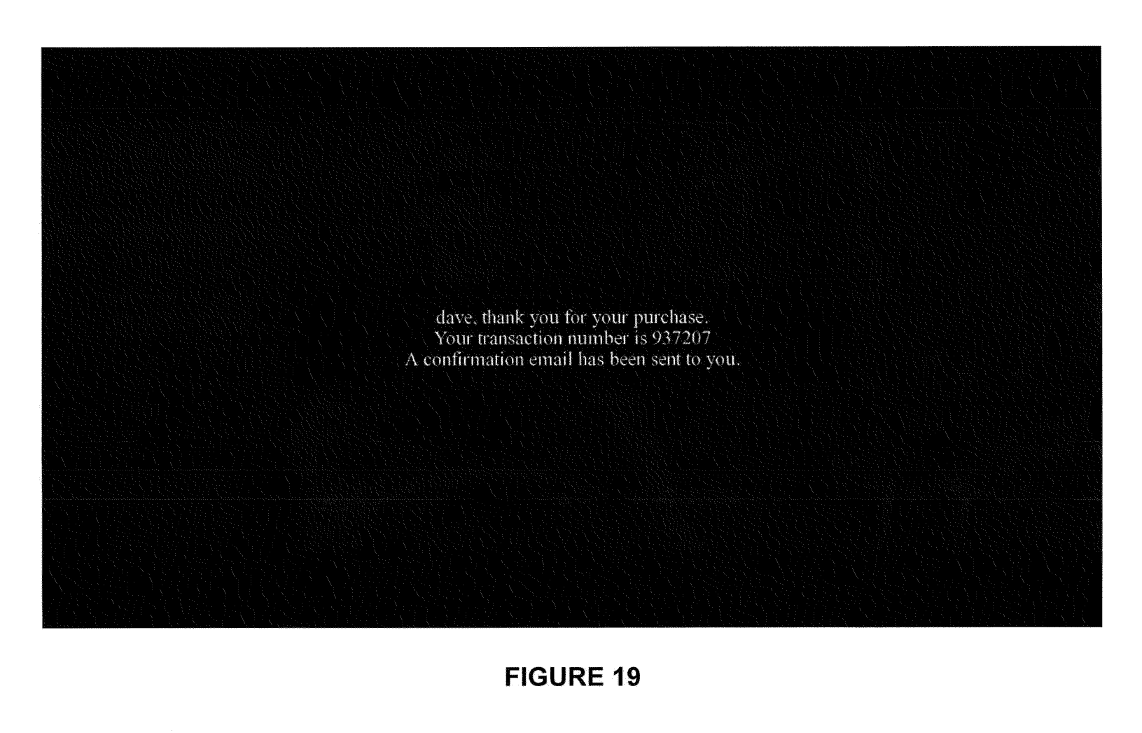

When the interactive content system is activated by the user, the display may also have one or more interactive content system icons wherein the user can point to those icons (such as by navigating using the remote cursor) to activate certain functions of the interactive content system. For example, there may be an interactive content icon 64 and a bookmark icon 66. The interactive content icon 64 allows the user to enter the interactive content mode as described below with reference to FIGS. 8-19. The bookmark icon 66 allows the user to bookmark a scene, place, item, person, etc. in the piece of content so that the user can later go back to the bookmarked scene, place, item, person, etc. and view them.

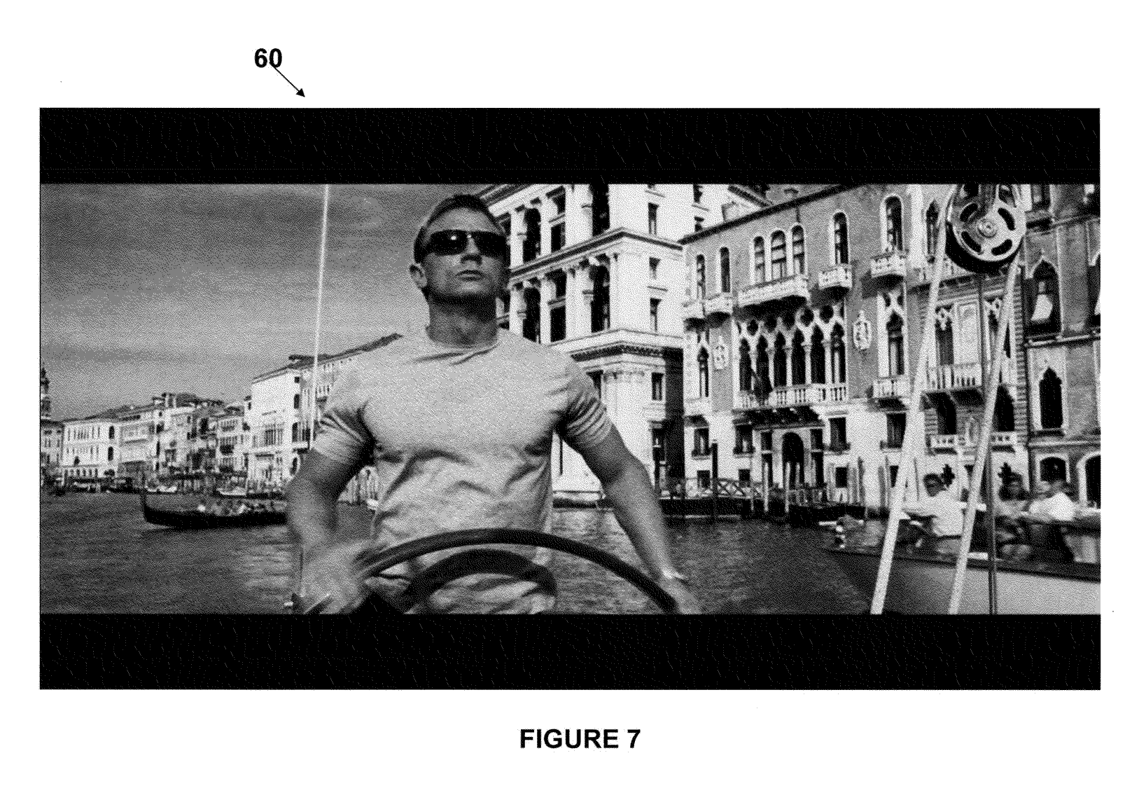

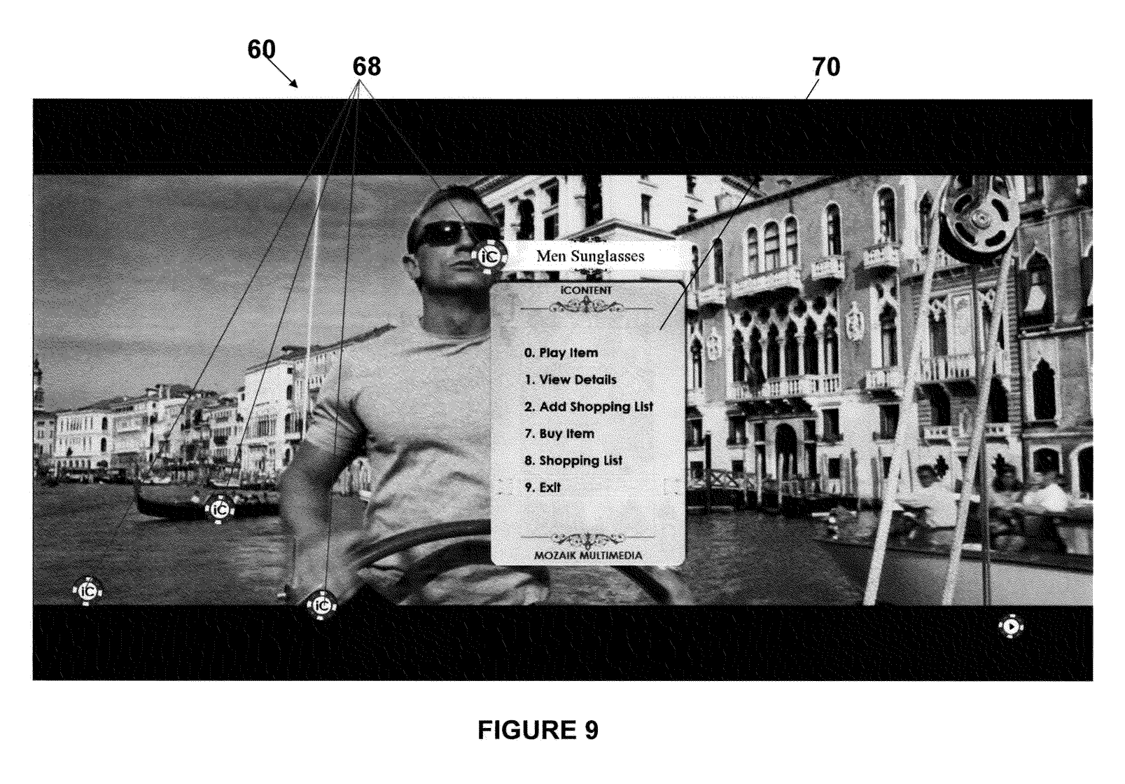

FIG. 7 illustrates a scene 60 from a piece of content being displayed to a user when the interactive content system is not activated whereas FIG. 8 illustrates the scene 60 from the piece of content in FIG. 7 when the interactive content system is activated by the user. As shown in FIG. 8, each piece of interactive content in the scene 60 is marked by an interactive content marker 68 wherein the user can select any one of the markers using the cursor. The particular visual icon used for the content markers 68 can be customized to each piece of content. For example, when the piece of content has a gambling/poker theme, the markers 68 may be a poker chip as shown in the examples below. When the user selects a marker as shown, the marker also displays a legend for the particular piece of interactive content (a pair of men's sunglasses in the example shown in FIG. 8). In FIG. 9, the other pieces of interactive content may be a location (Venice, Italy), a gondola, a sailboat and the sunglasses.

FIG. 9 illustrates the scene from the piece of content in FIG. 7 when a menu user interface of the interactive content system is displayed. When a user selects a particular piece of interactive content, such as the sunglasses, a menu 70 is displayed to the user that gives the user several options to interact with the content. As shown, the menu permits the user to: 1) play item/play scenes with item; 2) view details; 3) add to shopping list; 4) buy item; 5) see shopping list/cart; 6) see ‘What's Hot” (not shown in FIG. 9); 7) See “What's next” (not shown in FIG. 9); and 8) exit the menu and return to watching the content.

The “What's Hot” menu selection provides the user with interactive content (downloaded over the link 24 from the interactive content system 26) about other products of the producer of the selected interactive content. For example, when the sunglasses is selected by the user, the “What's Hot” selection displays other products from the same manufacturer that might be of interest to the user which permits the manufacturer to show the products that are more appropriate for a particular time of year/location in which the user is watching the piece of content. Thus, even though the interactive content is not appropriate for the location/time of year that the user is watching the content, the interactive content system permits the manufacturer to show the user different products (using the “What's Not” selection) that are more appropriate for the particular geographic location or time of year when the user is viewing the piece of content. For example, if the selected interactive content is a pair of sandals made by a particular manufacturer in a scene of the content on a beach during summer, but the user watching the content is watching the content in December in Michigan or is located in Greenland, the “What's Hot” selection allows the manufacturer to display boots, winter shoes, etc. made by the same manufacturer to the user which may be of interest to the user when the content is being watched or in the location in which the content is being watched.

The “What's Next” menu selection provides the user with interactive content (downloaded over the link 24 from the interactive content system 26) about newer/next versions of the interactive content to provide temporal advertising. For example, when the sunglasses is selected by the user, the “What's Next” selection displays newer or other versions of the sunglasses from the same manufacturer that might be of interest to the user. Thus, although the piece of content has an older model of the product, the “What's Next” selection allows the manufacturer to advertise the newer models or different related models of the products. Thus, the interactive content system prevents the interactive content from becoming stale and less valuable to the manufacturer such as when the product featured in the content is no longer made or sold.

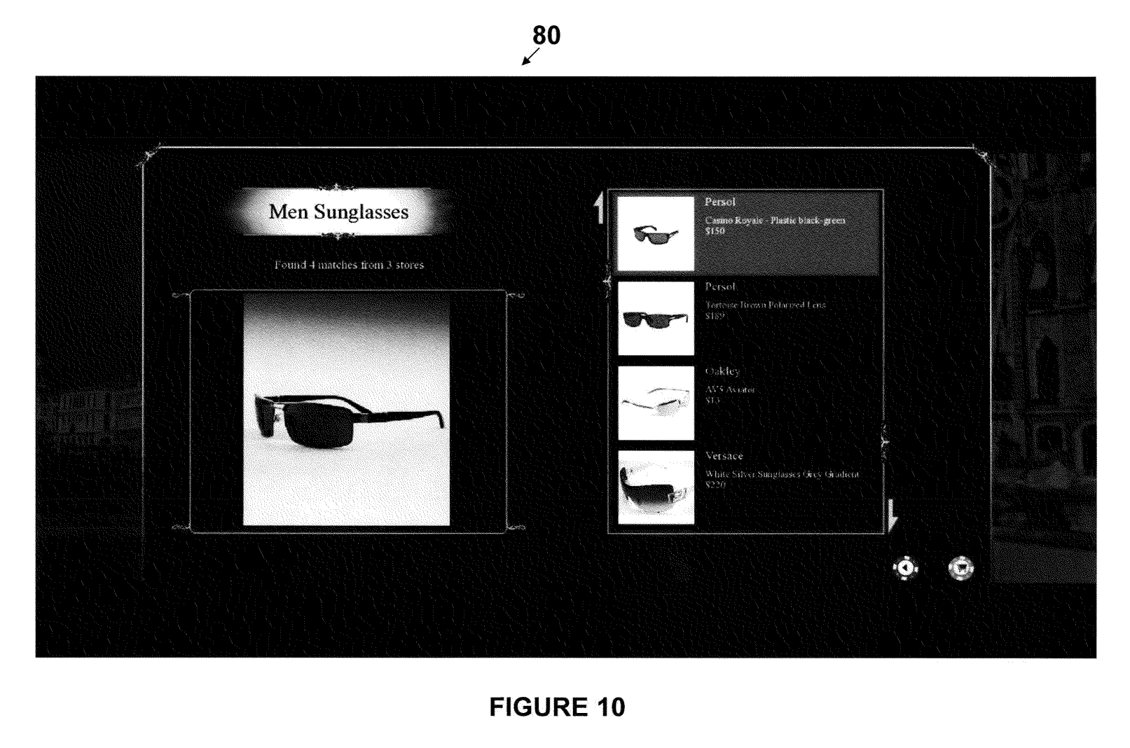

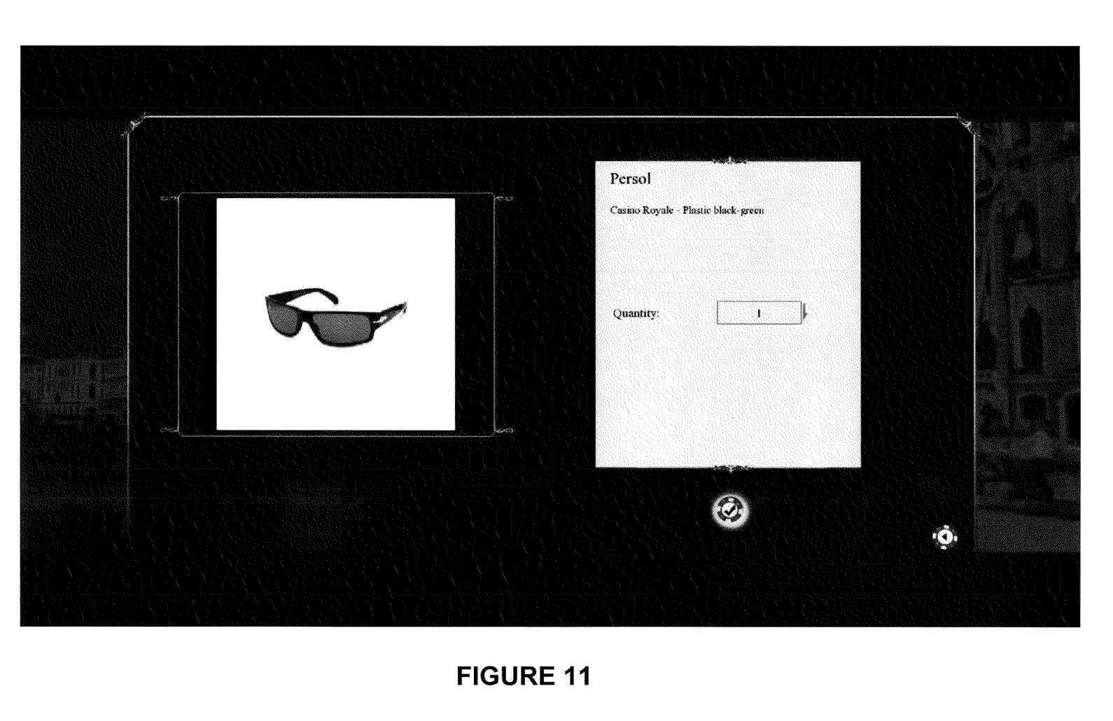

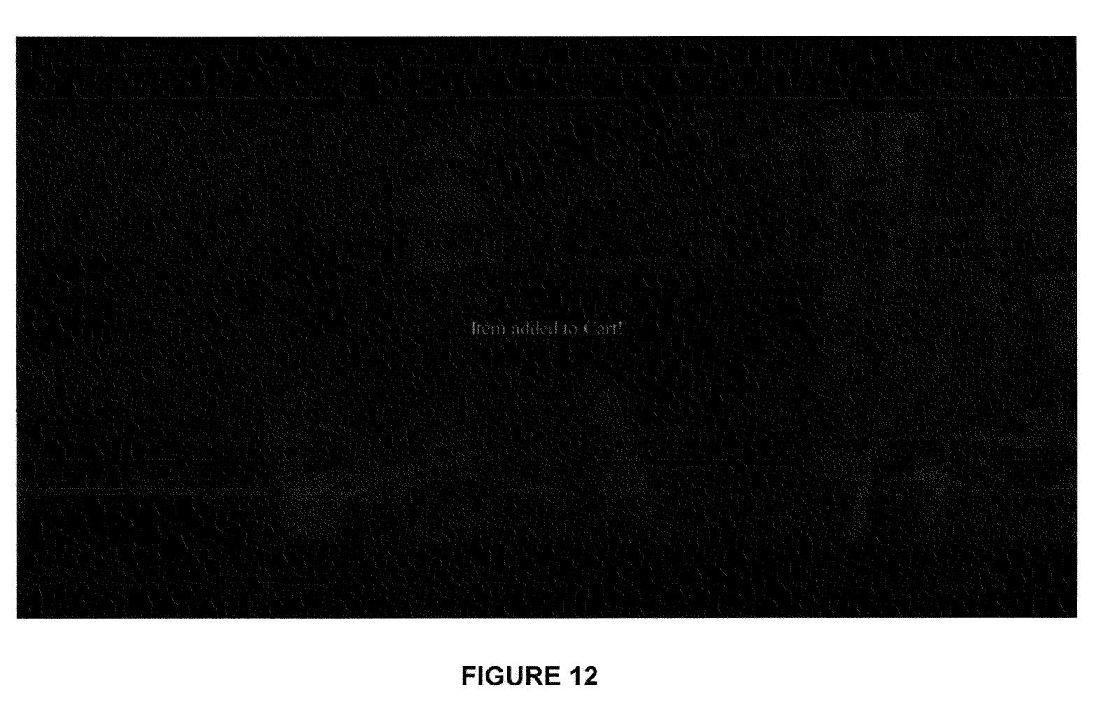

The view details menu item causes the interactive content system to send information to the content system that is displayed to the user as a item detail user interface 80 as shown in FIG. 10. Although the item shown in these examples is a product (the sunglasses), the item can also be a person, a location, a piece of music/soundtrack or a service wherein the details of item may be different for each of these different types of items. In the example in FIG. 10, the user interface shows details of the item as well as identification of stores from which the item can be purchased along with the prices at each store. The item detail display may also display one or more similar products (such as the Versace sunglasses or Oakley sunglasses) to the selected product that may also be of interest to the user. As shown in FIG. 11, the interactive content system allows the user to add the product to a shopping cart and provides feedback that that item is in the shopping cart as shown in FIG. 12. An piece of interactive content may be added into the shopping cart from the menu as shown in FIG. 9 or from the item detail displays as shown in FIGS. 10-11.

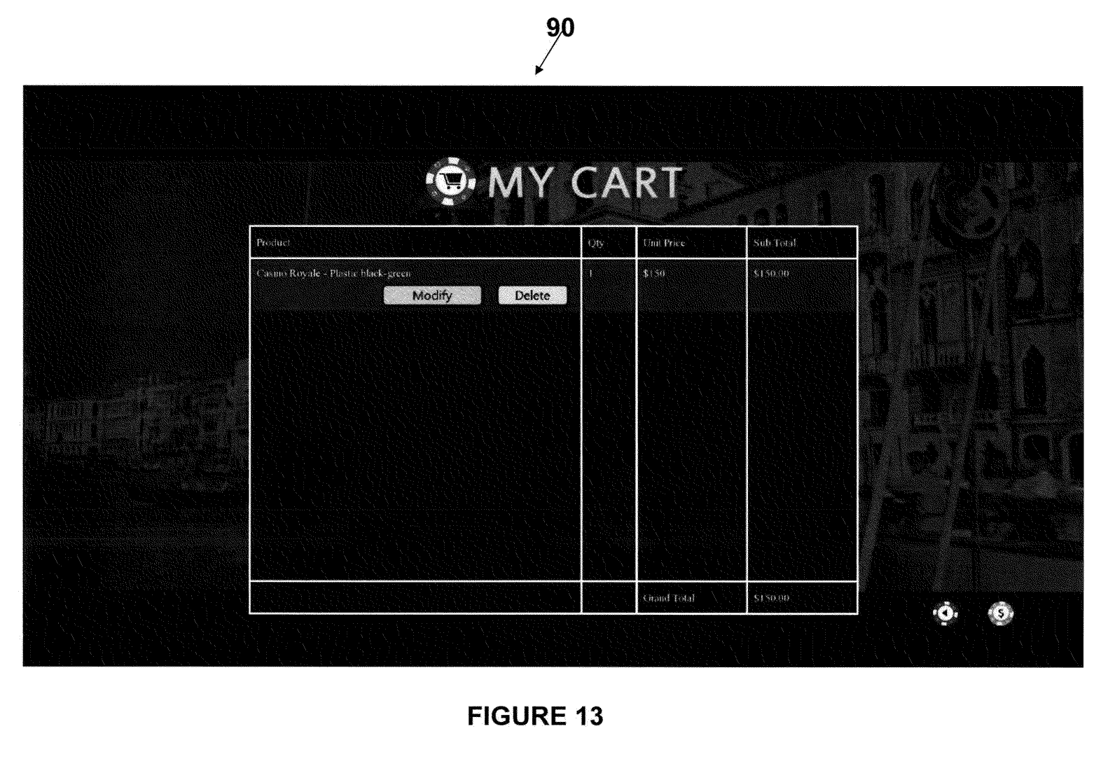

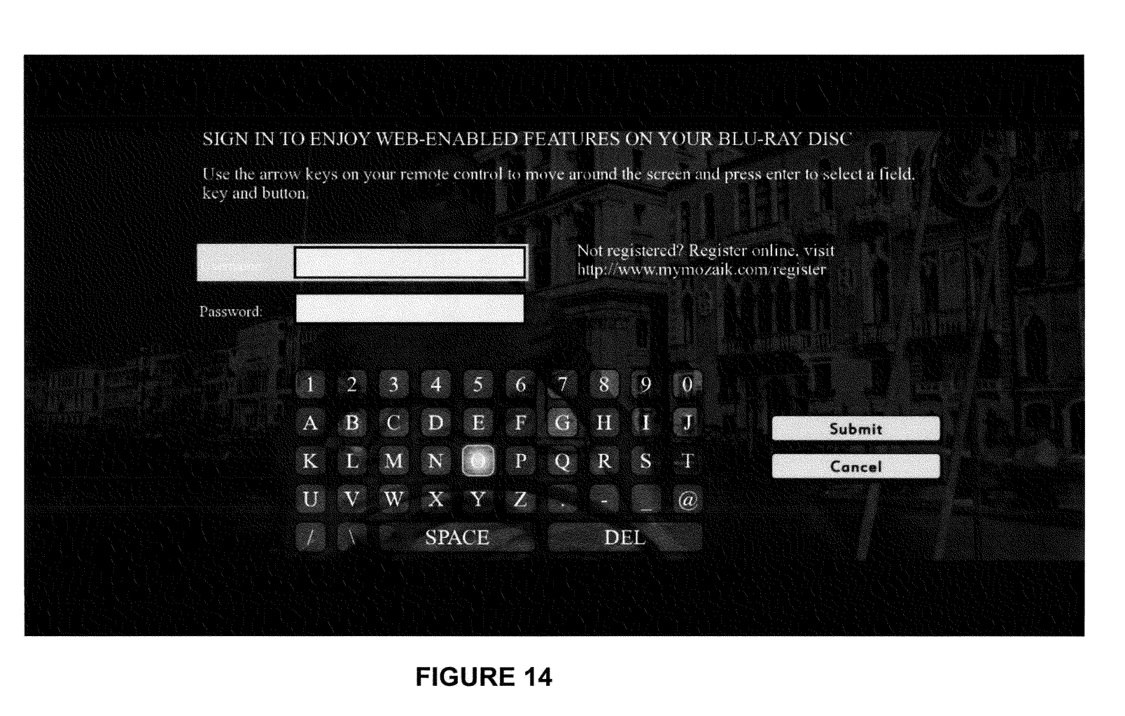

Returning to FIG. 9, when the user selects the “See shopping list/cart” item from the menu, a shopping cart user interface 90 as shown in FIG. 13 is displayed to the user. The shopping cart user interface has the typical shopping cart elements that are not described herein. As shown in FIG. 14, the interactive system allows the user to log into the interactive content system to perform various operations such as the purchase of the items in the shopping cart.

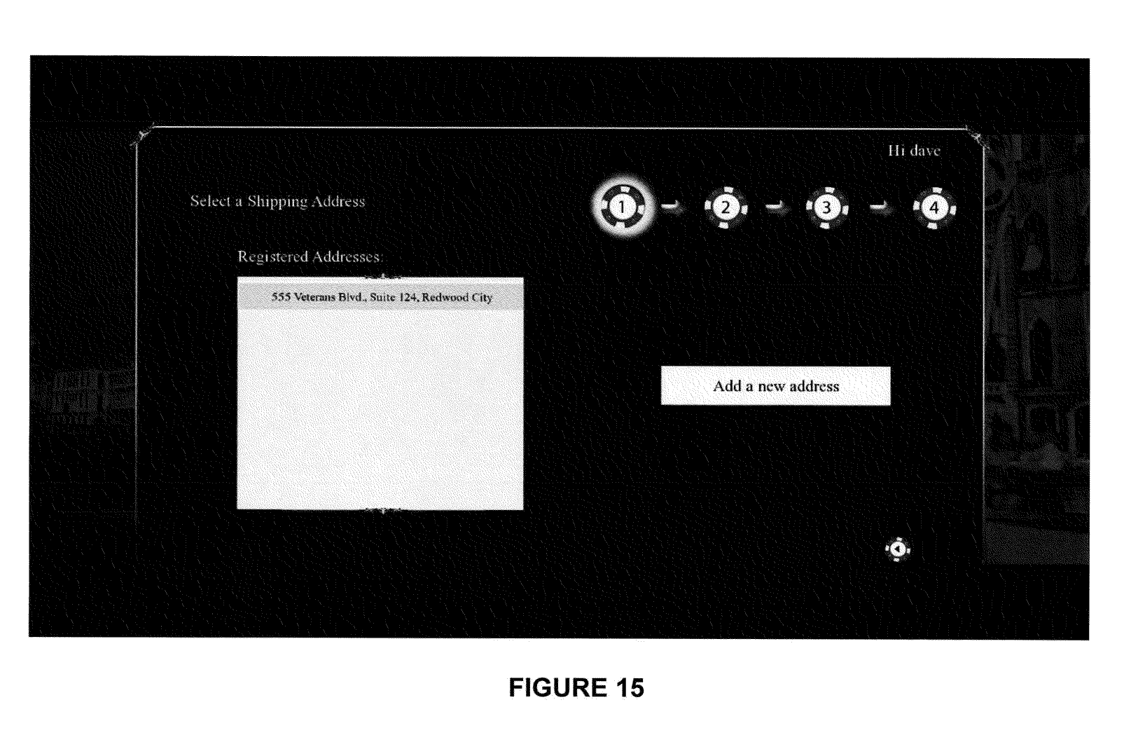

When a user selects the “Buy Item” menu item or when exiting the shopping cart, the interactive content system uses the ecommerce system as described above to permit the user to purchase the items in the shopping cart. Examples of the user interfaces for purchasing an interactive content are shown in FIGS. 15-19.

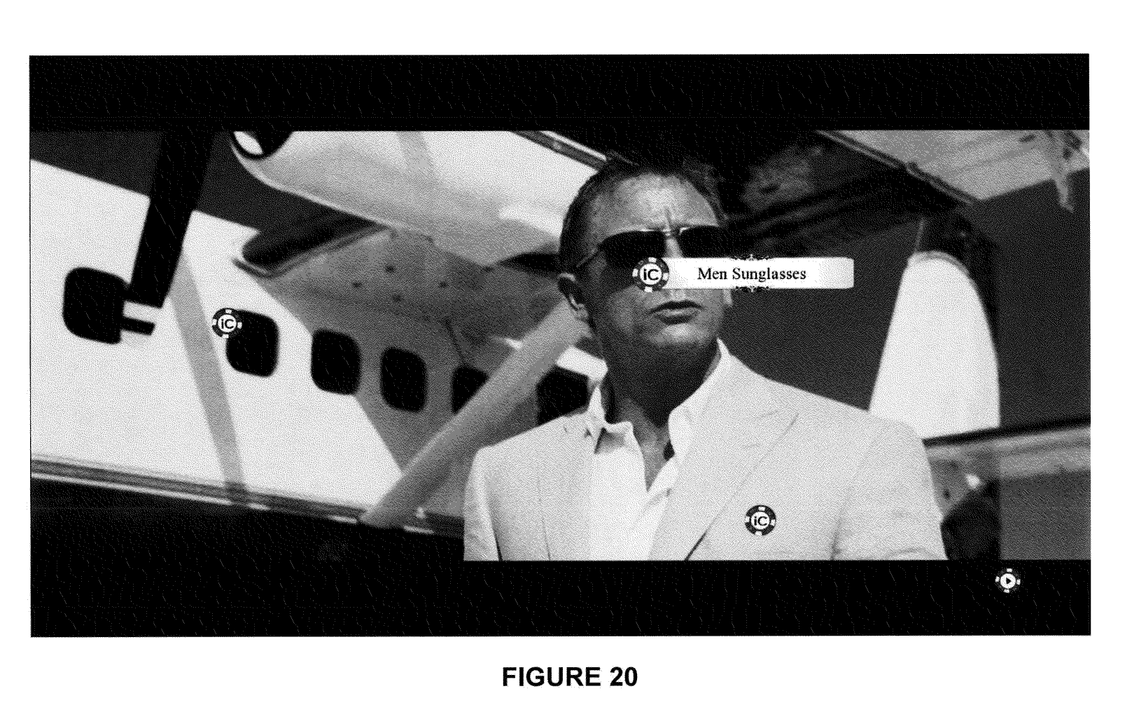

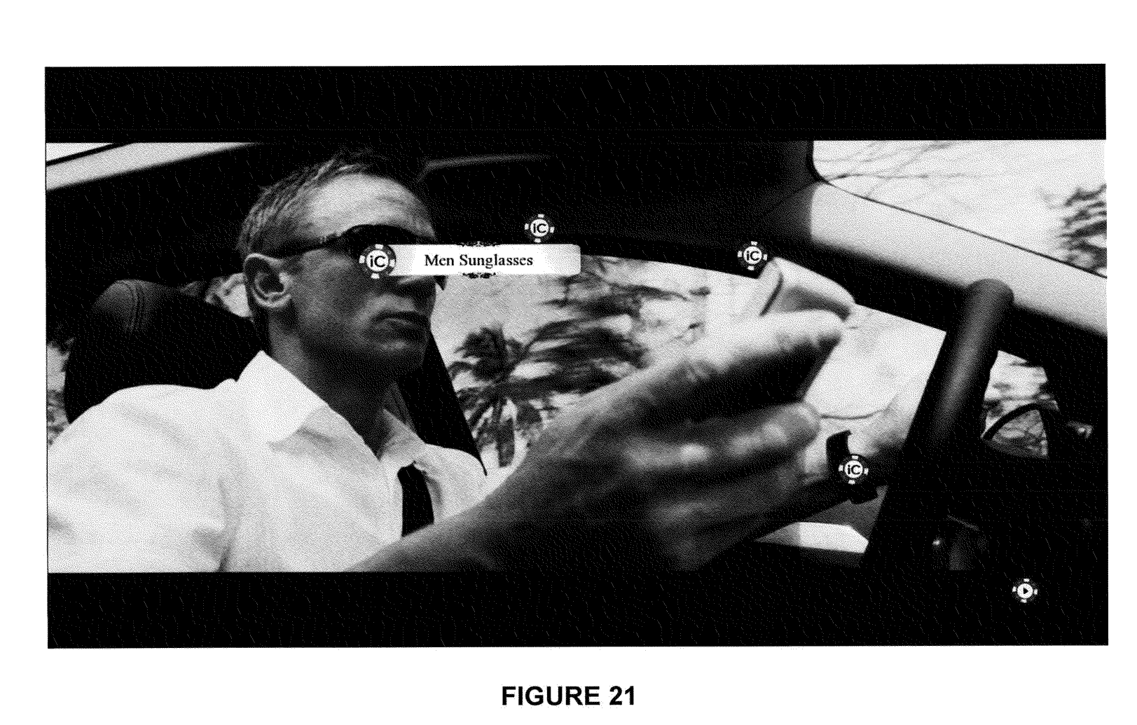

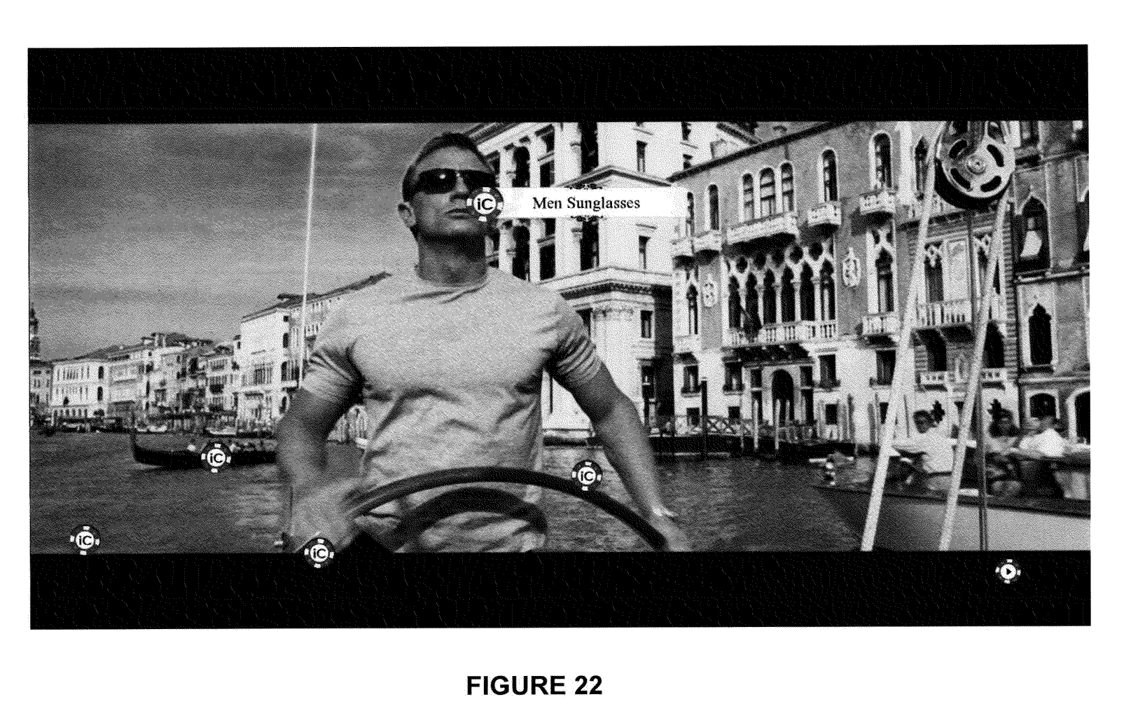

The play item/play scene selection shows the user each scene in the piece of content in which the selected interactive content is displayed as described in more detail with reference to FIGS. 20-22. In particular, FIGS. 20-22 show several different scenes of a piece of content that have the same interactive content (the sunglasses in this example) in the scene. Furthermore, since the interactive content system processes and metalogs each piece of content, the interactive content system can identify each scene in which a particular piece of interactive content is show and then be capable of displaying all of these scenes to the user when requested.

The interactive content system may also provide a content search feature. The content search is based in part on the processed content and the interactive content information. The search feature also allows the user to take advantage of the interactive content categories (products, people, places/locations, music/soundtracks, services and/or words/phrases) to perform the search. The search feature allows a user to perform a search in which multiple terms are connected to each other by logical operators. For example, a user can do a search for. “Sarah Jessica Parker AND blue shoes” and may also specify the categories for each search term. Once the search is performed at the interactive content system 26, the results are sent to the content system for display. The system will also allow the user to view the scenes in the piece of content that satisfy the search criteria. In an alternative embodiment, the digital media has code that allows some searching as described above to be performed without internet connectivity.

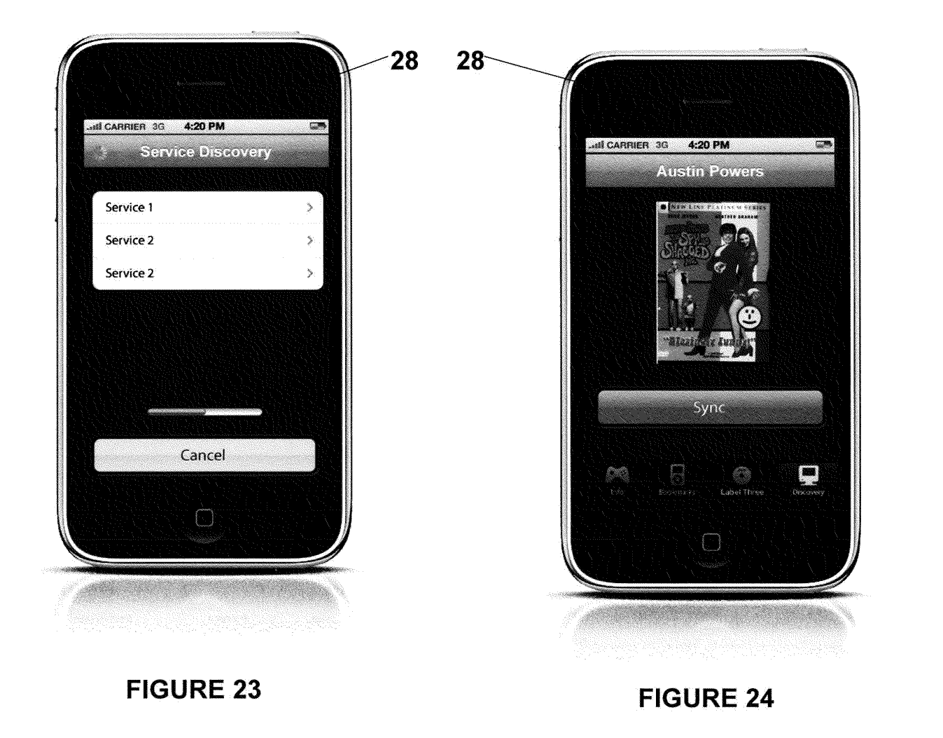

FIG. 23 illustrates an example of the computing device 28 user interface when the computing device is detecting a content system. In particular, the user can launch an interactive content application on their computing device that sends out a multicast ping to content devices near the computing device to establish a connection (wireless or wired) to the content system. The user interface in FIG. 23 shows the computing device in the process of establishing the connection. In a multiuser environment with multiple users, the system permits multiple user to establish a connection to the content system so that each user can has their own, independent interactions with the content.

FIG. 24 illustrates an example of the computing device 28 user interface when the computing device is being synched to a particular piece of content displayed on the content system. In particular, each computing device can be synchronized to a piece of content, such as the movie Austin Powers in the example shown in FIG. 24. In more detail, once each computing device has established the connection, each computing device has its own independent feed of content which means that each computing device can capture any scene of the content (when the content is a movie as shown) independent of the other computing devices by selecting the sync button from the user interface.

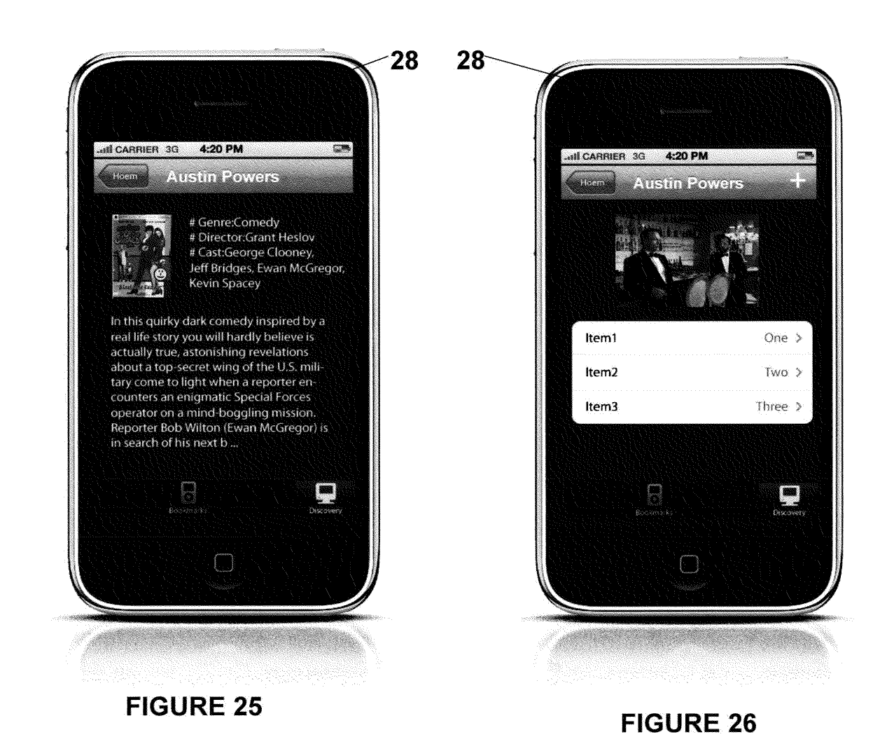

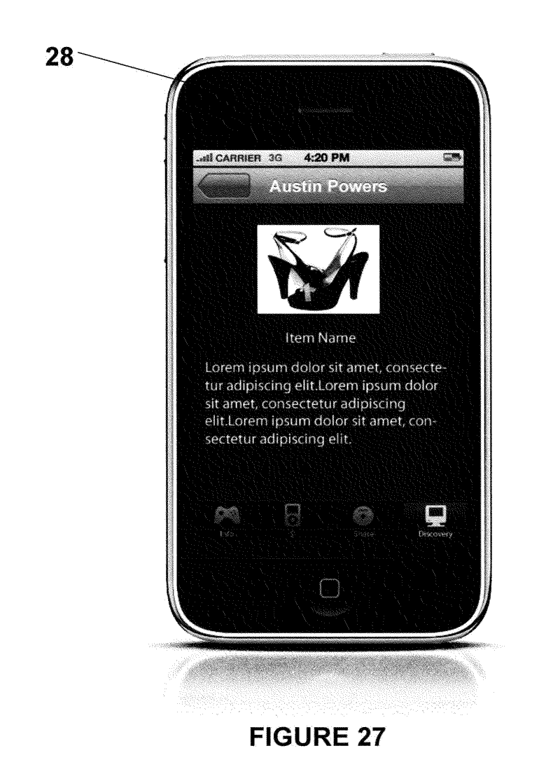

FIG. 25 illustrates an example of the computing device 28 user interface showing the details of the particular piece of content wherein each computing device can view the details of the content. FIG. 26 illustrates an example of the computing device 28 user interface once the computing device is synched to a particular piece of content and has captured a scene wherein the captured scene for the particular computing device is shown along with the search interface that allows the user to search for particular interactive content. Once the particular computing device has synched to a scene of the content, the user can perform the same interactivity operations (play item/play scenes with item; view details; add to shopping list; buy item; see shopping list/cart; see ‘What's Hot” (not shown in FIG. 9); and See “What's next”) as described above. An example of the item detail on the computing device is shown in FIG. 27. The computing device may also allow the user to share the scene/items, etc. with another user and/or comment on the piece of content.

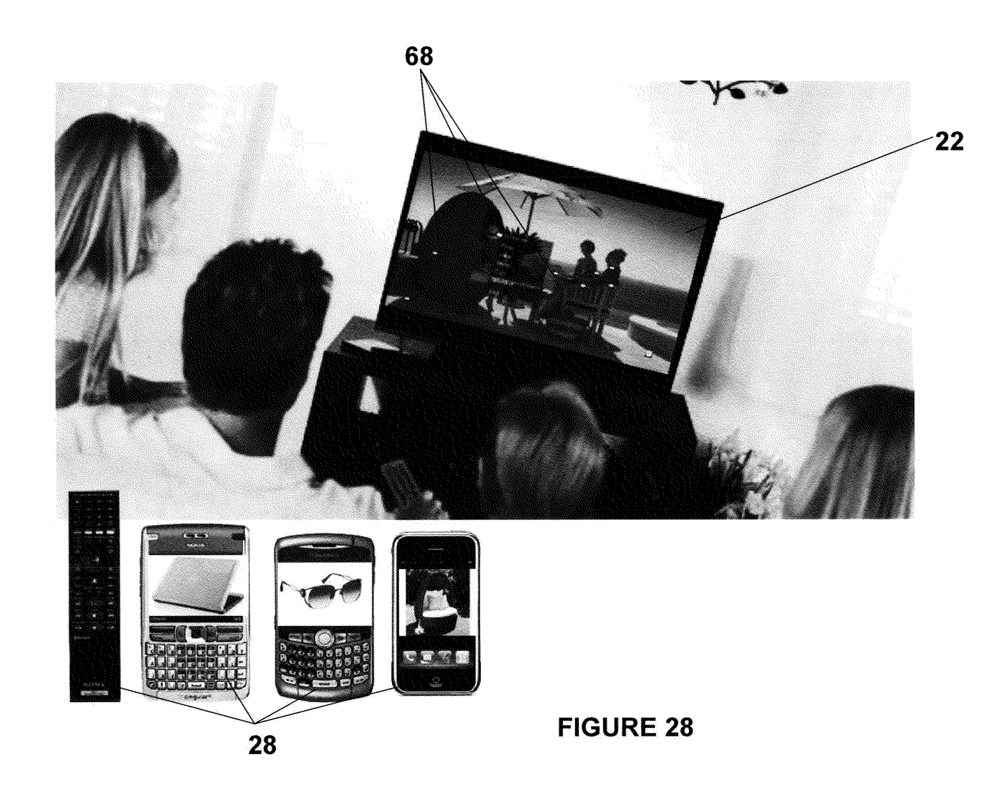

FIG. 28 illustrates multiple user independently interacting with content using the multiuser interactive content system. In particular, the content system 22 is displaying a movie piece of content and each user is using a particular computing device 28 to view the details of a different product in the scene wherein each of the products is marked using the interactive content landmarks as described above. As shown, one user is looking at the details of the laptop, while another user is looking at the glasses or the chair.

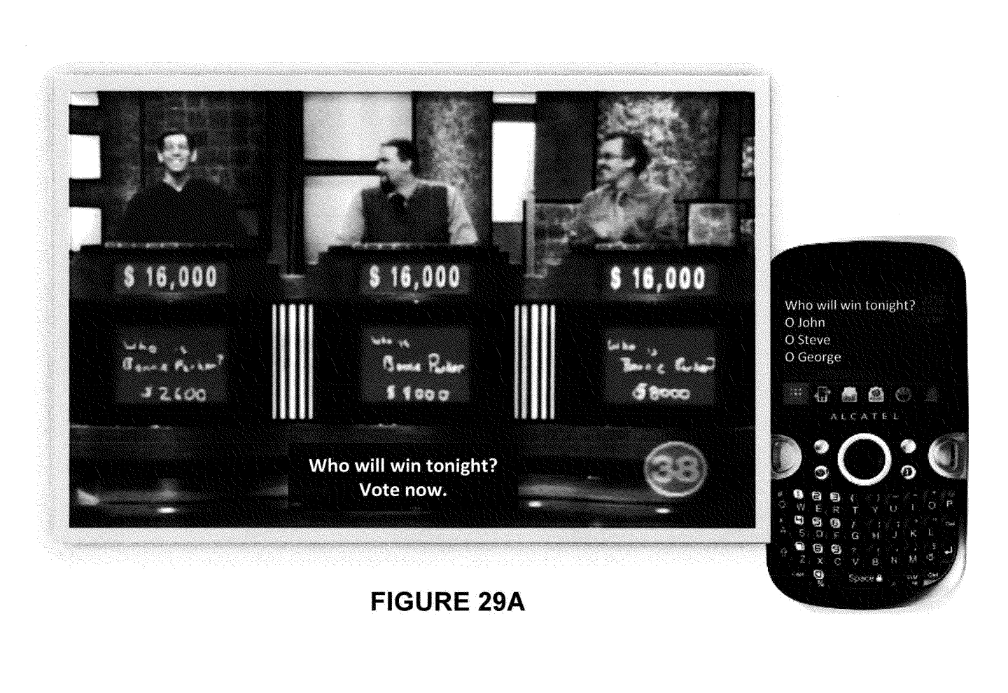

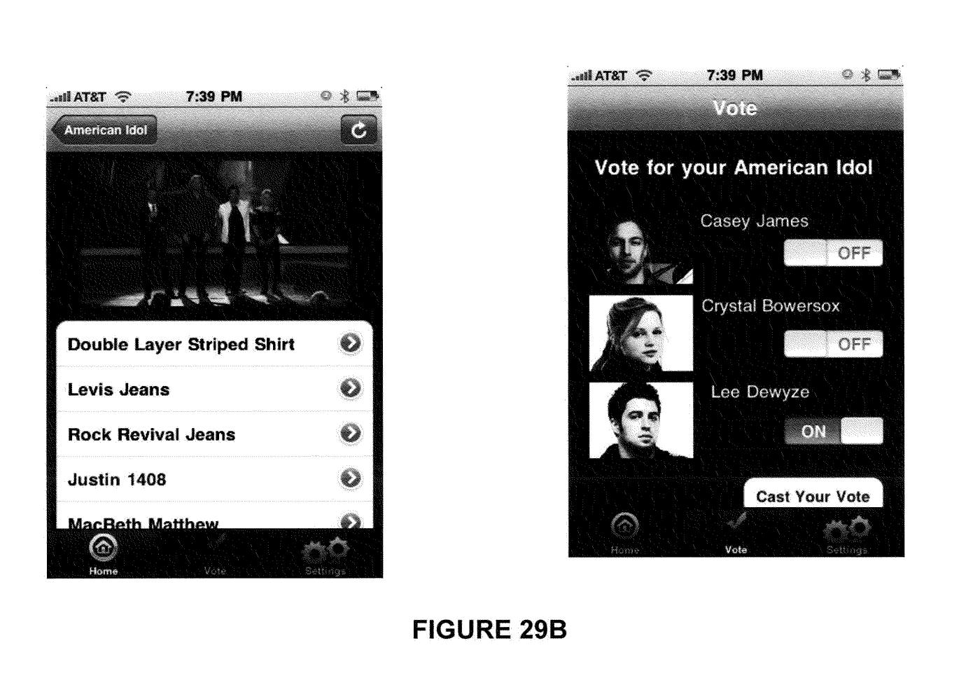

When the two or more computing devices of users are synchronized to the same live or recorded broadcast, the interactive content system also allows each user to vote in a voting situation. For example, if the broadcast is a political debate, the user is able to vote for the candidate who the user believes was better in the debate or who the user thinks will win the election. The voting may be accomplished by the user making a vote in some manner using the computing device so that the vote is sent back to the interactive content system. FIGS. 29A and 29B illustrate examples of voting that can be done using a computing device and the interactive content system.

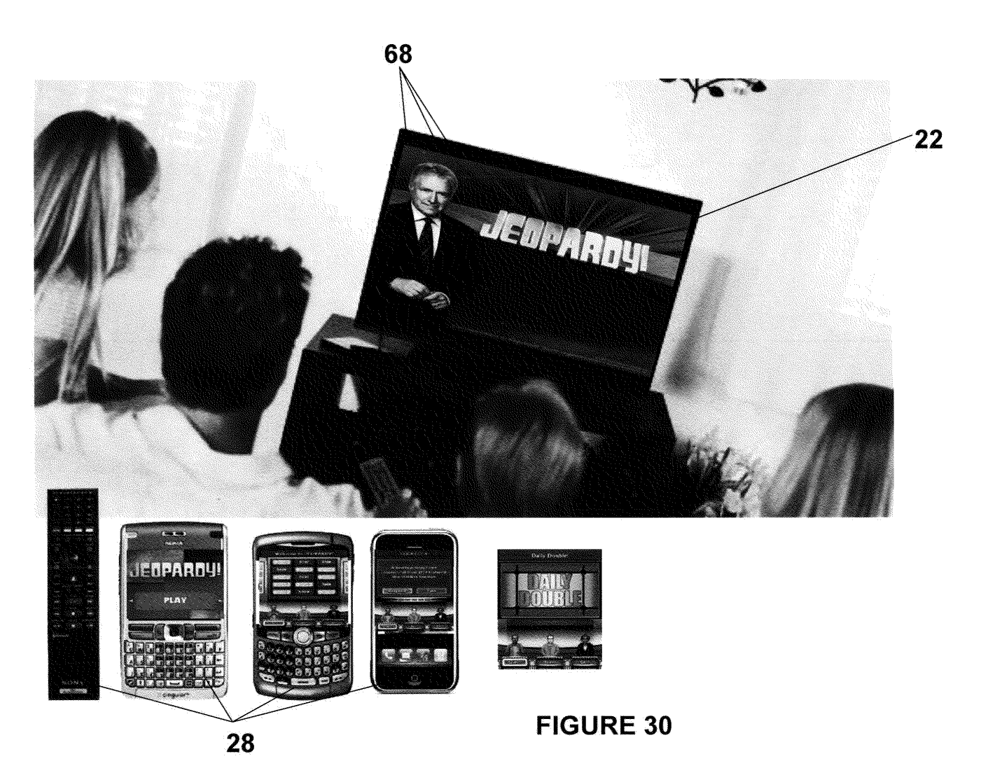

In addition, when the two or more computing devices of users are synchronized to the same live or recorded broadcast, each user may participate in a television show or a game show. For example, each user can synchronize to the game show Jeopardy and then answer the question using their computing device wherein the answers are sent back to the interactive content system that may then display, for example, a score for each user. FIG. 30 illustrates an example of participating in a game show using a computing device and the interactive content system. When two or more users are using the same link to access the interactive content system, the system may also provide scoring for the two or more users so that, for example, at the end of the game show, a winner is indicated by the system. Similarly, two or more users (using the same link or different links) can participate in fantasy sporting games in which each user may, for example, guess the statistics for each player and the interactive content system keeps track of the scores.

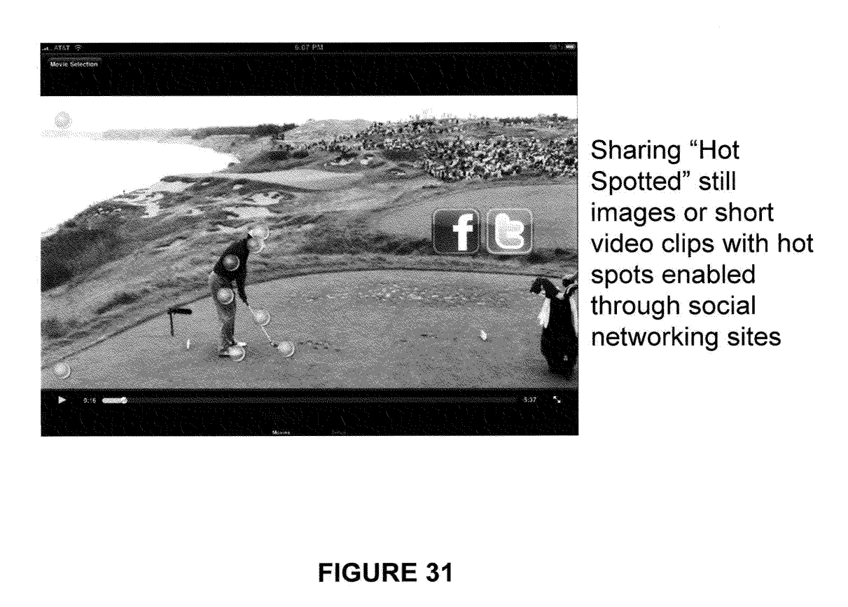

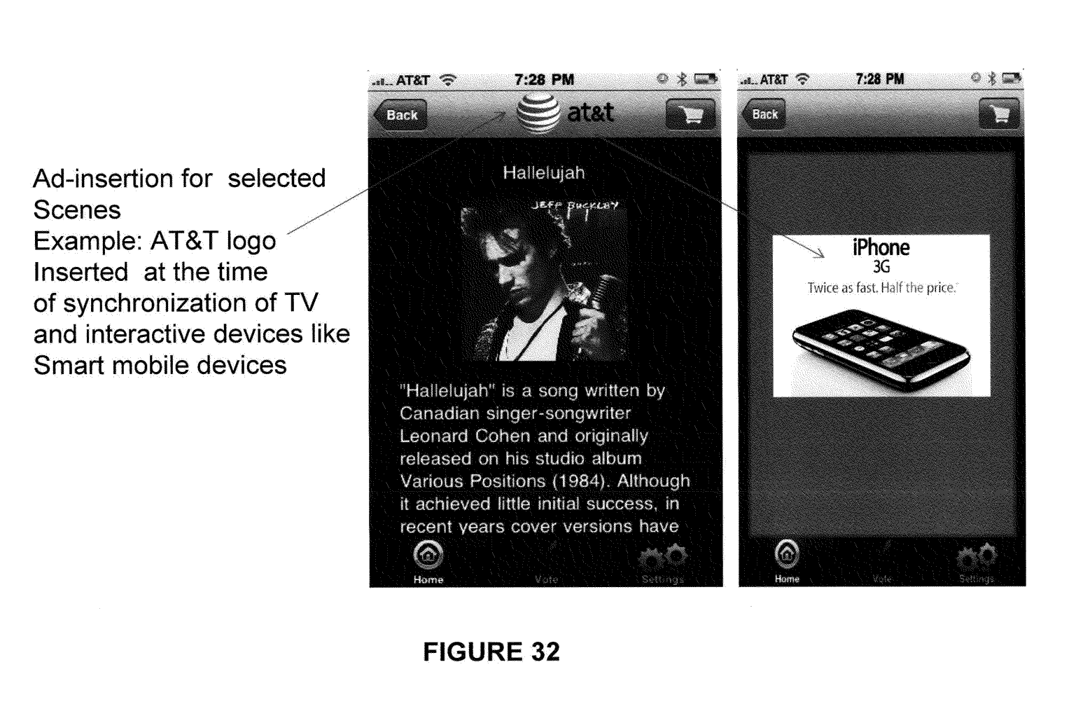

Furthermore, when the two or more computing devices of users are synchronized to the same live or recorded broadcast, the system allows each user to capture an item shown in the broadcast, a still image of a scene in the broadcast or a video clip of a portion of the broadcast (collectively “captured content”) on the computing device of the particular user and then the particular user can share the captured content with other people by uploading the captured content to existing social networking systems and sites or an internal social network. FIG. 31 illustrates an example of a user being able to share a piece of captured content using the interactive content system. When the user shares the captured content, the interactive content system is able to insert messaging material into the captured content being shared using a messaging material unit of the interactive content system that may be implemented in software. The messaging material may be stored in a message material store of the interactive content system and the messaging material may include advertisements, logos, promotional material, marketing material, interactive content, etc. FIG. 32 illustrates an example of a messaging material added into a piece of captured content and an interactive advertisement using the interactive content system. The messaging material may be selected by the interactive content system based on the captured content so that the interactive content system is delivering highly targeted messaging material which can be a significant source of revenue for the interactive content system. In addition, the messaging material may be interactive as well so that, the logo in the captured content will launch/download a commercial is clicked on by the person who receives the shared captured content.

While the foregoing has been with reference to a particular embodiment of the invention, it will be appreciated by those skilled in the art that changes in this embodiment may be made without departing from the principles and spirit of the disclosure, the scope of which is defined by the appended claims.

1. An interactive content system, comprising:
a content system that displays content to one or more users, wherein each user controls the content system using a computing device, the content having a plurality of interactive content landmarks embedded into the content; and
an interactive content system, connectable to the content system over a link, that provides interactive content to the content system when a particular user selects one of the interactive content landmarks.

2. The system of claim 1 further comprising:
a plurality of computing devices that can couple to the content system; each computing device permitting a user of the computing device to synchronize with a particular scene of the piece of content and select one of the interactive content landmarks in the content;
the interactive content system providing interactive content to each of the plurality of computing devices when the user selects one of the interactive content landmarks; and
wherein each computing device can be synchronized to any scene in the content and select any of the plurality of interactive content landmarks embedded into the content so that each computing device can independently interact with the content.

3. The system of claim 1, wherein the content system is one of a digital disc player, a personal computer, a laptop computer, a consumer two way IP enabled devices, a set-top box and a television with two way IP connectivity.

4. The system of claim 2, wherein each computing device is one of a smart phone, a camera with two way IP connectivity, a camcorder with two way IP connectivity, a cellular phone, a PDA, a palm top computer, a laptop computer, a play console/video game device, a smart remote TV controller; a tablet PC, a Digital Photo device with IP connectivity and a personal communication device.

5. The system of claim 1, wherein the content system has a physical media port and wherein a plurality of lines of code are stored on the physical media to be downloaded to the content system to provide the interactive content.

6. The system of claim 1, wherein the content system further comprises a plurality of lines of code downloaded to the content system over a link to provide the interactive content.

7. The system of claim 1, wherein the interactive content system further comprises a processor and metalogger unit that extracts one or more keywords from a piece of content and a particular location in the piece of content of the keyword and associates an interactive content landmarks with the particular location in the piece of content and an ecommerce unit that can process transactions facilitated by the interactive content system.

8. The system of claim 7, wherein the interactive content system further comprises one or more encoders that re-encode the content.

9. The system of claim 1, wherein the interactive content system further comprises a content search feature based on the content and the a plurality of interactive content landmarks embedded into the content.

10. The system of claim 2, wherein each computing device further comprises an interactive content application on the computing device that allows the synchronization of the computing device.

11. An interactive content method, comprising:
displaying, using a content system, content to one or more users, wherein each user controls the content system using a computing device and the content has a plurality of interactive content landmarks embedded into the content; and
providing interactive content to the user when a particular user selects one of the interactive content landmarks in the content.

12. The method of claim 11 further comprising:
synchronizing each of a plurality of computing devices to a particular scene of the piece of content wherein each computing device can be synchronized to any scene in the content;
selecting, using each computing device, one of the interactive content landmarks in the content, wherein each computing device select any of the plurality of interactive content landmarks embedded into the content so that each computing device can independently interact with the content; and
providing, using an interactive content system, interactive content to one of the plurality of computing devices when a particular user selects one of the interactive content landmarks.

13. The method of claim 11, wherein providing interactive content further comprises displaying a piece of content to the user, activating, by the user, the interactive content system, retrieving, by the interactive content system, the interactive content and displaying the interactive content landmarks to the user.

14. The method of claim 11 further comprising facilitating, using an ecommerce unit of the interactive content system, transactions by the user.

15. The method of claim 11 further comprising providing a content search based on the interactive content and the interactive content landmarks.

16. An interactive content system, comprising:
a content system that displays content to one or more users, wherein each user controls the content system using a computing device, the content having a plurality of interactive content landmarks embedded into the content;
a plurality of computing devices that can couple to the content system; each computing device permitting a user of the computing device to synchronize with a particular scene of the piece of content and select one of the interactive content landmarks in the content;
an interactive content system providing interactive content to each of the plurality of computing devices when the user selects one of the interactive content landmarks; and
wherein each computing device can be synchronized to any scene in the content so that each computing device can independently interact with the same piece of content.

17. The system of claim 16, wherein each computing device permits the user of the computing device to vote and the interactive content system receives a piece of voting data from the computing device.

18. The system of claim 16, wherein each computing device permits the user of the computing device to participate in the piece of content wherein the piece of content is one of a television show, a game show and a sporting event and the interactive content system receives a piece of participating data from the computing device.

19. The system of claim 18, wherein the interactive content system generates a score for each user based on the piece of participating data from each computing device.

20. The system of claim 16, wherein each computing device permits the user of the computing device to capture a piece of captured content from the piece of content and share the piece of captured content using a social networking site.

21. The system of claim 20, wherein the piece of captured content is one of an item shown in the piece of content, a still image of a scene in the piece of content and a video clip of a portion of the piece of content.

22. The system of claim 20, wherein the interactive content system further comprises an messaging material unit that selects a piece of messaging material and inserts the piece of messaging material into the piece of captured content.

23. The system of claim 22, wherein the piece of messaging material is one of an advertisement, a logo, a piece of promotional material, a piece of marketing material and a piece of interactive content.
